(19) United States
(12) Patent Application Publication
(10) Pub. No.: US 2007/0026102 A1
(43) Pub. Date: Feb. 1, 2007

(54) Systems and methods of solid freeform fabrication with improved powder supply bins

(76) Inventors: John A. Devos, Corvallis, OR (US); Terry M. Lambright, Corvallis, OR (US); Isaac Farr, Corvallis, OR (US); Jeffrey A. Nielsen, Corvallis, OR (US); Tony S. Cruz-Uribe, Corvallis, OR (US); David C. Collins, Philomath, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/191,797

(22) Filed: Jul. 28, 2005

(51) Int. Cl. B28B 21/42

(52) U.S. Cl. 425/375

(57) ABSTRACT

Solid freeform fabrication systems, powder supply bins for solid freeform fabrication systems, and methods of solid freeform fabrication are disclosed. One exemplary solid freeform fabrication system includes a removable powder supply bin, a build bin, a roller, and a print head disposed above the build bin that deposits a binder onto the powder in the build bin in a preselected pattern.

### BACKGROUND

When solid freeform fabrication uses a three-dimensional (3D) printing process, a number of printed planar layers are combined together to form a non-planar, three-dimensional object. Objects are fabricated by printing or ejecting an adhesive or binder onto a flat bed of powder. Where the binder is ejected, the powder is solidified into a cross section of the object being formed. This printing is performed layer-by-layer, with each layer representing another cross section of the final desired product. Adjacent printed layers are adhered to one another in predetermined patterns to build up the desired product.

In addition to selectively forming each layer of the desired object from the powder in the fabrication chamber, the system can print a color or color pattern on each layer of the object. For example, inkjet printing technology can be employed in which a number of different colored binders (or non-colored binders) are selectively ejected from the nozzles of a print head to provide a full spectrum of colors. On each individual layer, two-dimensional multi-pass printing techniques and half-toning algorithms can be used to hide printing defects and achieve a broad range of desired color hues.

With powder-based 3D printers, an operator typically scoops powder from a container provided by the powder supplier, and pours the powder into one or more bins in the 3D printer. The powder is then spread back and forth, planarized and packed, to prepare the powder for the powder spreading and subsequent printing processes. This typically causes at least some of the powder to spill in an around the sides of a supply bin in the 3D printer, and this spill must be cleaned up prior to printing. Additionally, the uncontained airborne powder-particles that can create a respiratory hazard and a widely distributed mess. Additionally, powder must also be scooped or vacuumed out if the user desires to recycle the unused powder, to clean the bins, or to change powder types. It would be desirable to have a solid freeform applicator that is easier and less messy to use, or to change powder types.

### BRIEF DESCRIPTION OF THE DRAWINGS

Many aspects of this disclosure can be better understood with reference to the following drawings. The components in the drawings are not necessarily to scale. Moreover, in the drawings, like reference numerals designate corresponding, but not necessarily identical, parts throughout the several views.

FIG. 1 illustrates a solid freeform fabrication system that uses a printing process to fabricate desired products. An embodiment of the present invention can be implemented in the system illustrated in FIG. 1.

FIG. 2 illustrates a partial top view of the solid freeform fabrication system of FIG. 1, showing an exemplary supply bin.

FIG. 3 illustrates a cross sectional view of an embodiment of the supply bin taken along section line A-A in FIG. 2.

FIG. 4 illustrates a cross sectional view of an embodiment of the supply bin taken along section line A-A in FIG. 2.

FIG. 5 illustrates a side view of an embodiment of the disclosed supply bin.

FIG. 6 is a flow diagram illustrating an embodiment of a disclosed method of solid freeform fabrication.

### DETAILED DESCRIPTION

The disclosed solid freeform fabrication systems have incorporated therein a convenient supply powder packaging. The supply powder bin can include a removable top, four side walls, and a piston-like bottom that supports the powder, and allows a printer piston to feed powder to the spreader during the printing and object fabrication process. The disclosed supply powder bins can be either disposable or reusable. The disclosed supply powder bins simplify the set-up process, as well as cut down on powder-related mess caused by the powder spilling and the clean up that has typically been associated with three-dimensional (3D) printing and selective laser sintering (SLS) processes.

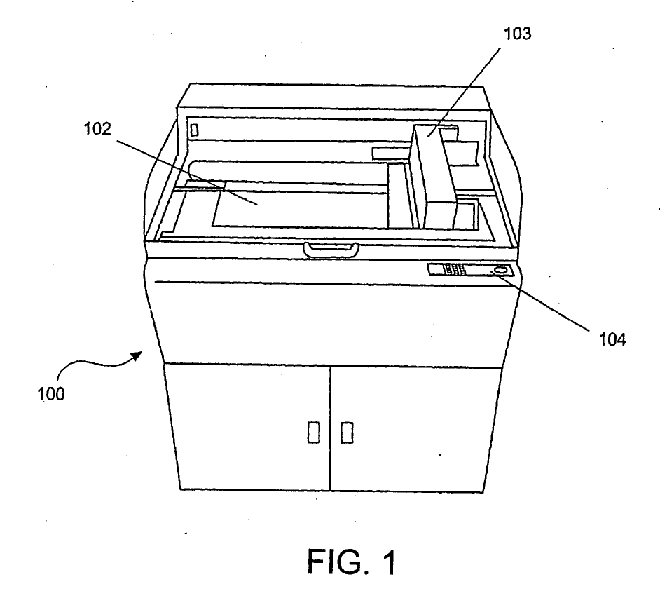

Having thus generally described the disclosed solid freeform fabrication systems, reference will now be made to the figures. FIG. 1 illustrates one solid freeform fabrication system that uses 3D printing technology. The disclosed powder bins, apparatuses, and methods can also be applied to SLS systems.

In the solid freeform fabrication system 100 of FIG. 1, a powdery material (e.g., a plaster- or starch-based powder) is used to form each individual layer of the desired product. To do this, a measured quantity of powder is first provided from a supply chamber or bin in the solid freeform fabrication system 100. A roller, preferably incorporated into a moving stage 103, then distributes and compresses the powder at the top of a fabrication chamber or build bin 102 to a desired thickness. Then, a print head (not shown) deposits an adhesive or binder onto the powder in the build bin 102 in a two dimensional pattern. This two dimensional pattern is a cross section of the desired product. The print head may also eject colored binder, toner, and/or color activator into the layer of powder to provide a desired color or color pattern for this particular cross section of the desired product. Although a print head is described with respect to FIG. 1 as an example, other binding apparatuses can be used, for example, a laser that sinters the powder.

The powder becomes bonded in the areas where the adhesive or binder is deposited, thereby forming a layer of the desired product. After each layer of the 3D object is fabricated, the build bin 102 (in which the object sits) is repositioned downward along the z-axis so that the next layer of the object can be formed on top of the previously formed layer. By way of example, the build bin 102 can have dimensions such as 8″×10″×10″ or 6″×6″×6″ to accommodate fabricators and 3D objects of various sizes.

The process is repeated with a new layer of powder being applied over the top of the previous layer in the build bin 102. The next cross section of the desired product is then printed with adhesive or binder into the new powder layer. The adhesive also serves to bind the adjacent or successive layers of the desired product together. This process continues until the entire object is formed within the powder bed in the build bin 102. The extra powder that is not bonded by the adhesive is then brushed away leaving the base or “green” object. A user interface or control panel 104 can be provided to allow the user to control the fabrication process.

The solid freeform fabrication system 100 also includes a controller (not shown) which is programmed to, among other things, control the positioning and repositioning of the print head 103 during the 3D object fabrication process. The controller can take the form of a discrete module positioned proximate to the print head; alternatively, the operations performed by the controller can be distributed among a plurality of controllers, processors or the like, and/or the controller can be remotely located relative to the print head.

Such a printing process offers the advantages of speedy fabrication and low materials cost. It is considered one of the fastest solid freeform fabrication methods, and can be performed using a variety of colors.

The print head in the solid freeform fabrication system 100 may include inkjet technology for ejecting a binder or adhesive on a powder layer to form the layers of the desired object. In inkjet technology, the print head ejects drops of binder in a selective pattern to create the image being printed, or in the case of solid freeform fabrication, to color the object being fabricated. As used herein and in the attached claims, the term “binder” is used broadly to mean any substance ejected by a print head to form an object being fabricated. Consequently, the term “binder” includes, but is not limited to, binders, adhesives, etc. The binder can be, for example, clear (to create non-colored parts) or colored (to create colored objects or parts of objects).

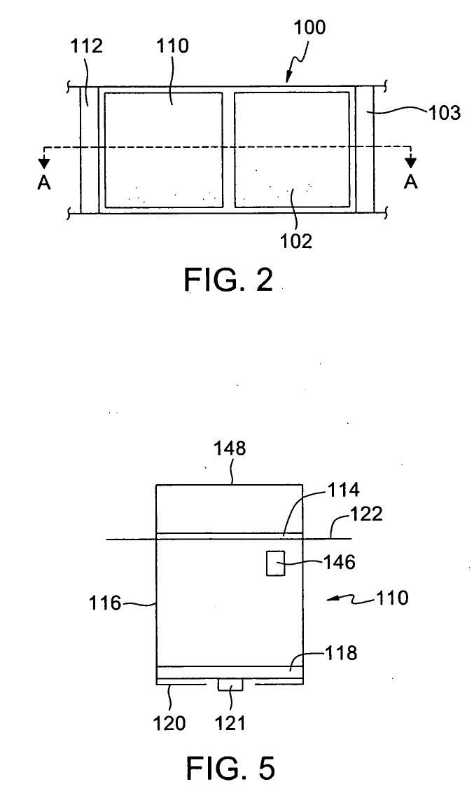

FIG. 2 illustrates a partial top view of the solid freeform fabrication system 110 of FIG. 1, showing an exemplary supply bin 110. Also depicted is a build bin 102 adjacent the supply bin 110. The roller 112 traverses the supply bin 110, and moves a very thin layer of powder from the top surface of the supply bin 110 onto a platform of the build bin 102. Thereafter, the print head 103 deposits the binder onto the powder layer on the platform of the build bin 102, thereby forming one layer of the desired object. The supply bin 110 is designed to be easily removable from the system 100. The supply bin 110 can thus be reused for another fabrication or disposed of.

FIG. 3 illustrates a partial cross section an embodiment of the disclosed solid freeform fabrication system 100, taken along section line A-A in FIG. 2. FIG. 3 shows the exemplary supply bin 110 (a) when first placed into the system 100, and (b) upon partial deployment of powder 128 from the supply bin 110. The supply bin 110 includes an optional removable lid 114, rigid boundaries or side walls 116 (e.g., four side walls for a square or rectangular bin), and a bottom moveable platform 118 that can be operated in the z-direction by a piston cylinder 119 already in place in the solid freeform fabrication system 100. The supply bin 110 can have a quick-release interface 121 that interacts with a linear motion actuator 119 such that the actuator 119 can engage the bottom moveable platform 118. Although the quick-release interface can be, for example, a latch, a magnet, or other device(s) that would allow the actuator 119 to easily engage and then release the platform 118. The actuator is depicted in FIG. 3 (a) as a piston cylinder, it could instead be, for example, linear motors, lead screws, servo motors, hydraulic pistons, air-driven pistons, etc.

As shown in FIG. 3 (a), when the supply bin 110 is placed into the system 100, the side walls 116 fit into and lock in place within a supply bin housing 126. The supply bin housing 126 can have, for example, grooves that can accommodate matching protrusions on the supply bin 110 (not shown), or simple mechanical latches. The supply bin 110 can have a pair of upper flanges 122 that extend beyond the side walls of the bin in the y-direction, and engage at least one upper working surface 124 in the system 100. The upper flanges 122 engage an upper surface 124 of the bin housing 126 and aid in placement of the supply bin 110 and/or maintaining the supply bin 110 in place during operation of the system 100. In place of the flanges 122, one embodiment of the supply bin 110 can have mechanical latches or magnets to ensure that only the powder is lifted by the actuator 119, and not the entire bin 110 itself. Positive downward force can be applied by cam action or springs in the latches.

Alternatively, or in addition, the powder bin 110 can include vertical registration components such vertical pins with hardened points on the tips, located in the system 100, that contact either the bottom surface 118 or the flanges 122 or lip around the bin 110. Use of registration components minimize the possibility of powder interfering with the registration interface. Further, the bin 110 can include one or more seating sensors (not shown) to detect when the bin 110 is properly seated in the system 100. Seating sensor(s) can be, for example, an electrical continuity check, a Hall effect sensor, a through-beam or reflected light sensor, and/or a high precision switch.

In one embodiment, the linear motion actuator 119 pushes upward on the bottom moveable platform 118, which fits exactly inside the side walls 116 of the supply powder bin 110. In one embodiment, the supply bin 110 has a pair of lower flanges 120 that extend beneath and parallel to the bottom moveable platform 118, on which the platform 118 rests when the supply bin 110 is initially inserted into the system 100, as shown in FIG. 3 (a).

As depicted in FIG. 3 (b), the lid 114 is removed, thereby exposing the powder 128. The actuator 119 acts on the platform 118 to push the platform 118 upwardly. A thin layer of powder 128 is exposed, which can be rolled forward in the y-direction toward the build bin 102 by the roller 112 (see FIG. 2) for each layer of the device fabrication.

The optional removable lid 114 can be, for example, a lid that peels back, or even completely off, or that snaps onto and off of a lip (not shown) of an upper surface of the supply bin 110. The lid can also be designated, as in a snap-fit lid, to be re-installed after fabrication of an object. The material of the supply bin 110 can be any material that is sufficiently rigid to support a bin full of powder or slurry. For example, the material can be a metal or metal alloy, cellulosic material, or hard, stiff plastic (e.g., thermosets and thermoplastics, including for example, acetals, acrylics, terpolymers, alkyds, melamines, phenolic resins, polyarylates, polycarbonates, high density polyethylene, polyphenylene sulfide, polystyrene, polyvinyl chloride, styrene acrylonitrile, polyphenylsulfone, sulfones, unsaturated polyesters, polypropylene, polytetrafluoroethylene, polyethersulfone, polyetherketone, liquid crystalline polymers, or urea-formaldehyde molding compounds, etc.). The material of the supply bin 110 can also include fillers for the polymers, the fillers being designed to be compatible with each polymer. The fillers can impart various properties to the polymeric material, such as increased strength. The supply bin 110 can be designed to be either disposable or reusable, depending on the material selected for the supply bin 110.

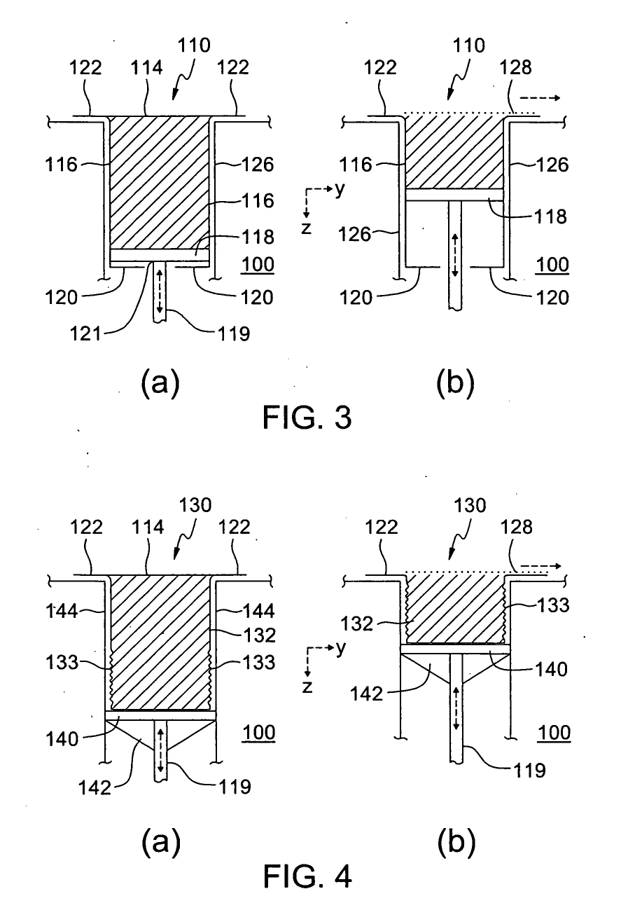

FIG. 4 illustrates a cross sectional view of an embodiment of the supply bin 130 taken along section line A-A in FIG. 2, the supply bin 130 being a bag-like material. FIG. 4 shows the exemplary supply bin 130 (a) when first placed into the system 100, and (b) upon partial deployment of powder 128 from the supply bin 130. The supply bin 130 includes an optional removable lid 114, a bag compartment 132, and a pair of upper flanges 122 that extend from an upper surface of the bin 130.

The bag compartment 132 includes an optional crinkle zone 133 that enables the bag to fold easily as a platform 140 and the actuator 119 operate on the bag compartment 132 in the z-direction. The platform 140 and actuator 119 can be already in place in the system 100, and the supply bin 130 is inserted to rest on top of the platform 140. The actuator 119 in one embodiment can have optional struts 142 to stabilize the actuator 119 during movement. The struts 142 can be, for example, a stiff metal, metal alloy, or a hard plastic material.

The supply bin 110 can have a pair of upper flanges 122 that extend beyond the side walls. The upper flanges 122 engage an upper surface 124 of the bin housing 126 and aid in placement of the supply bin 130. Preferably, the upper flanges 122 are of a stiffer material than the bag compartment 132 in order to aid in proper placement of the bag compartment 132. The upper flanges can be made of, for example, a cellulose-based material (e.g., cardboard), a metal, or a hard plastic.

In one embodiment, the linear motion actuator 119 pushes upward on the platform 140, which fits exactly inside the side walls of a bin housing 144 in the system 100. As depicted in FIG. 4 (b), the lid 114 is removed, thereby exposing the powder. The actuator 119 acts on the platform 140 to push the platform 118 upwardly, in the z-direction. A thin layer of powder 128 is exposed, which can be rolled forward in the y-direction toward the build bin 102 by the roller 112 (see FIG. 2) for each layer of the device fabrication.

The optional removable lid 114 can be, for example, a lid that peels back, or even completely off, or that snaps onto and off of a lip (not shown) of an upper surface of the supply bin 130. The material of the bag compartment 132 can be any material that is sufficiently rigid to support a bin full of powder or slurry, yet sufficiently pliable to fold up, upon compression by the actuator 119 and platform 140. The bag compartment is chosen to provide a barrier to environmental conditions such as, for example, air, humidity, moisture, grease, and/or light, etc. For example, the material of the bag compartment 132 can be any flexible polymeric material. These include but are not limited to flexible films of polyvinyl chloride, polyvinylidene, polyethylene, polyethylene copolymers, polyethylene naphthalate, polyester, polyamide, polyarylates, polybutylene terepthalate, polypropylene, polyurethane, cellulosics, and polysaccharides. The supply bin 130 can be designed to be either disposable or reusable, depending on the material selected for the supply bin 130. By using a bag compartment 132 for the supply bin 30, the tolerance between the platform 140 and the side walls of the bin housing 144 can be reduced, as well as eliminating the need for o-rings that are typically used to create a tight seal.

By using a removable supply bin, unused powder that is contained in the supply bin can be easily removed from the solid freeform fabrication system for disposal or reuse by removing the packaging without the need for powder scooping or vacuuming. The supply bin can be reused at a later time, or the powder recycled from the supply bin for other uses.

In addition, as illustrated by FIG. 5, the supply bin 110 can include a memory mechanism 146 that can communicate information to the controller about the supply bin, such as, for example, powder volume, powder type, bin manufacturer (e.g., to help determine if the supply bin is a genuine supply bin), allowable binder types for the powder, recommended spread-roller rotation speed, supply bin z-step size, expiration date of the powder, drop volume needed for a given layer thickness, setting time, etc. The memory mechanism 146 can be, for example, an integrated circuit (IC) chip, a tag or label with a bar code, or a mechanical device that conveys information about the powder level and/or bin. The solid freeform fabrication system can include a sensor that is capable of reading the memory mechanism 146. For example, in the case of an IC chip, the system can use information from the supply bin in tandem with the information from the inkjet supply's memory chip to ensure, for example, that the correct binder liquid and powder are mixed. The system can also use the data encoded in or on the memory mechanism 146 to determine certain operating parameters, such as for example, print speed, drop volume per voxel, color maps, dry time needed after build completion, shrink or expansion size, adjustment factors, powder settling coefficients (e.g., to determine whether powder supports need to be included, and if so, how much support), minimum allowable layer thickness, etc.

Communication with the IC can be via contact pads or wireless via radio frequency signals. Generally the bar codes are read only, whereas the IC can be written to. The memory mechanism 146 can be placed anywhere on the supply bin, so long as it can be read by a sensor in or on the solid freeform fabrication system.

The supply bin 110 can include a handle 148. The handle 148 can be in any configuration (e.g., square or semicircular) and can be removable, collapsible, telescoping, and/or magnetic. In addition, the handle can be a notch or set of notches, inset into the supply bin 110. The bin 110 is designed so that it can be removed from the system 100 by grasping and pulling on the handle 148.

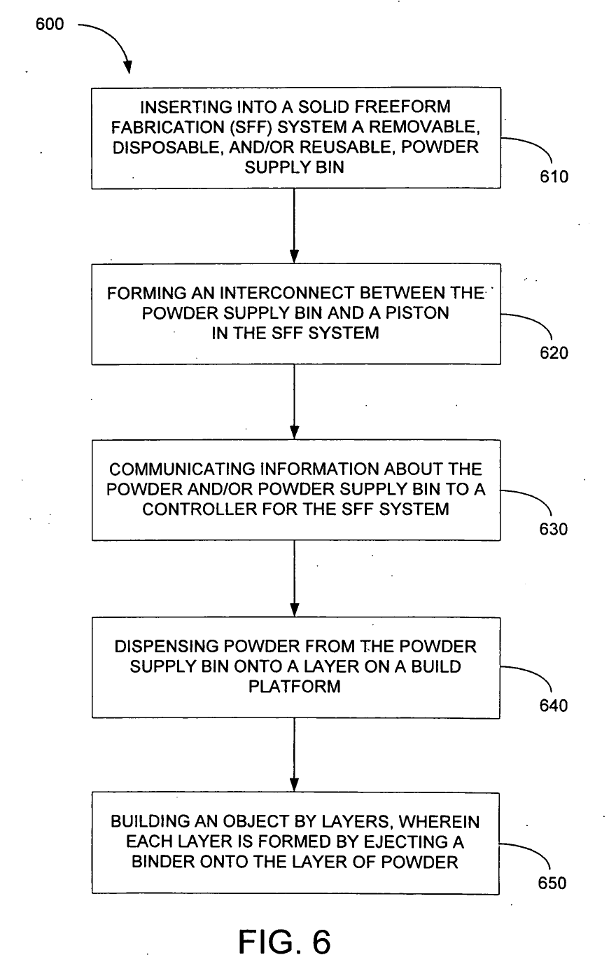

Also disclosed are methods of solid freeform fabrication, using the disclosed supply bins. FIG. 6 is a flow diagram describing a representative method 600 for forming a three-dimensional object, using the solid freeform fabrication system 100. In block 610, a removable, disposable, and/or reusable powder supply bin is inserted into a solid freeform fabrication system. In block 620, an interconnect is formed between the powder supply bin and a piston cylinder in the solid freeform fabrication system. Then, as shown in block 630, information can optionally be communicated from the powder supply bin to a controller for the solid freeform fabrication system. Powder is then dispensed from the powder bin onto a build platform, as shown in block 640. Block 650 shows how an object is built, by ejecting a binder from, for example, an inkjet print head, onto the layer of powder on the build platform, thereby forming layers of the object.

Many variations and modifications may be made to the above-described embodiments. All such modifications and variations are intended to be included herein within the scope of this disclosure and protected by the following claims.

At least the following is claimed:

1. A powder supply bin for a solid freeform fabrication system, comprising:
side walls; and
a piston bottom configured to be acted on by a drive mechanism of the solid freeform fabrication system,
wherein the bin is designed to be removable from the solid freeform fabrication system.

2. The bin of claim 1, wherein the bin further comprises a lid that peels back, or even completely off, or that snaps onto and off from the bin prior to fabrication of an object and re-installed on the bin after fabrication.

3. The bin of claim 1, wherein the piston bottom comprises a quick-release interface with the drive mechanism of the solid freeform fabrication system, wherein the interface is selected from the group consisting of: a set of magnets and a latching mechanism.

4. The bin of claim 1, wherein the bin further comprises a memory mechanism that is designed to communicate information about the powder to a controller for the solid freeform fabrication system, wherein the information is one of the group consisting of: powder volume, powder type, bin manufacturer, allowable binder types for the powder, recommended spread-roller rotation speed, supply bin z-step size, expiration date of the powder, drop volume needed for a given layer thickness, and setting time.

5. The bin of claim 1, wherein the bin further comprises a pair of flanges on the upper surface of the bin, wherein the flanges mechanically stabilize the bin in the solid freeform fabrication system by engaging at least one upper working surface of the system in which the bin is seated, whereby the ability of the bin to shift in the system is reduced.

6. The bin of claim 1, wherein the bin is constructed of a material chosen from at least one of the following: a metal, a metal alloy, cellulosic material, and hard, stiff plastic.

7. The bin of claim 1, wherein the bin is constructed of a polymeric material selected from the group consisting of: acetals, acrylics, terpolymers, alkyds, melamines, phenolic resins, polyarylates, polycarbonates, polyethylenes, polypropylene, polyphenylene sulfide, polystyrene, polyvinyl chloride, polytetrafluoroethylene, styrene acrylonitrile, polyphenylsulfone, polyethersulfones, polyetherketone, unsaturated polyesters, liquid crystalline polymers, polyurethanes, and urea-formaldehyde molding compounds.

8. The bin of claim 7, wherein the polymeric material includes fillers that increase the strength of the polymeric material, wherein the fillers are designed to be compatible with the polymeric material.

9. The bin of claim 1, further comprising a handle, wherein the handle allows the bin to be removed from the solid freeform fabrication system and refilled with powder while the bin is outside of the system.

10. A powder supply bin for a solid freeform fabrication system, comprising:
a bag compartment; and
wherein the powder supply bin is removable from the solid freeform fabrication system.

11. The powder supply bin of claim 10, further comprising a pair of flanges on the upper surface of the bin, the flanges engaging at least one upper working surface of the fabrication system that mechanically stabilizes the bin in the solid freeform fabrication system.

12. The powder supply bin of claim 10, wherein the bag compartment is constructed of a polymeric material.

13. The powder supply bin of claim 10, wherein the bag compartment is constructed of a polymeric film of one of the group consisting of: polyvinyl chloride, polyethylene, polyethylene copolymers, polyethylene naphthalate, polyester, polyamide, polyarylates, polybutylene terepthalate, polypropylene, polyurethane, cellulosics, and polysaccharides.

14. The powder supply bin of claim 10, wherein the bag compartment material provides a barrier to at least one of the group consisting of: air, moisture, grease, and light.

15. The powder supply bin of claim 10, wherein the bag comprises a memory mechanism that communicates data about the powder to a controller for the fabrication system, wherein the data includes at least one of the group consisting of: powder volume, powder type, bin manufacturer, allowable binder types for the powder, recommended spread-roller rotation speed, supply bin z-step size, expiration date of the powder, drop volume needed for a given layer thickness, and setting time.

16. A solid freeform fabrication system, the system comprising:
a removable powder supply bin;
a build bin adjacent the powder supply bin;
a roller incorporated into a moving stage, the roller configured to distribute and compress the powder at a top surface of the removable powder supply bin and the build bin to a desired thickness; and
a print head disposed above the build bin that deposits a binder onto the powder in the build bin in a preselected pattern.

17. The solid freeform fabrication system of claim 16, wherein the powder supply bin comprises:
side walls made of a material chosen from one of the group consisting of: acetals, acrylics, terpolymers, alkyds, melamines, phenolic resins, polyarylates, polycarbonates, polyethylene, polypropylene, polyphenylene sulfide, polystyrene, polyvinyl chloride, styrene acrylonitrile, polyphenylsulfone, polyethersulfones, polyetherketones, unsaturated polyesters, polytetrafluoroethylene, liquid crystalline polymer, polyurethanes, and urea-formaldehyde molding compounds; and
a piston bottom configured to be acted on by a linear motion actuator of the solid freeform fabrication system.

18. The solid freeform fabrication system of claim 16, wherein the powder supply bin comprises a bag compartment constructed of a flexible polymeric material.

19. The system of claim 16, wherein the powder supply bin comprises a bag compartment, the bag compartment being constructed of a polymeric film of one of the group consisting of: polyvinyl chloride, polyethylene, polyethylene copolymers, polyethylene naphthalate, polyamide, polyester, polyarylates, polybutylene terepthalate, polypropylene, polyurethane, cellulosics, and polysaccharides.

20. The solid freeform fabrication system of claim 16,
wherein the powder supply bin comprises a memory mechanism that communicates information about the powder to a controller for the solid freeform fabrication system, and
wherein the system comprises a sensor that is configured to receive information from the sensor on the powder supply bin.

21. A method of solid freeform fabrication, comprising the steps of:
inserting into a solid freeform fabrication system a powder supply bin;
forming an interconnect between the powder supply bin and a piston cylinder;
communicating information about the powder in the powder supply bin to a controller for the solid freeform fabrication system;
dispensing powder from the powder supply bin onto a layer on a build platform; and
building an object by layers, wherein each layer is formed by ejecting a binder onto the layer of powder with an inkjet print head.

22. The method of claim 21, wherein the powder supply bin comprises:
side walls made of a material chosen from the group consisting of: acetals, acrylics, terpolymers, alkyds, melamines, phenolic resins, polyarylates, polycarbonates, polyethylene, polypropylene, polyphenylene sulfide, polystyrene, polyvinyl chloride, styrene acrylonitrile, polyphenylsulfone, polyethersulfones, unsaturated polyesters, polyetherketones, liquid crystalline polymers, polytetrafluoroethylene, polyurethanes, and urea-formaldehyde molding compounds; and
a piston bottom configured to be acted on by a piston cylinder of the solid freeform fabrication system.

23. The method of claim 21, wherein the powder supply bin comprises a bag compartment constructed of a flexible polymeric material.

24. A solid freeform fabrication system, the system comprising:
means for inserting into a solid freeform fabrication system a removable, disposable powder supply bin;
means for forming an interconnect between the powder supply bin and a piston cylinder in the system;
means for communicating information about the powder in the powder supply bin to a controller for the solid freeform fabrication system;
means for dispensing powder from the powder supply bin onto a layer on a build platform;
means for building an object by layers, wherein each layer is formed by ejecting a binder onto the layer of powder with an inkjet print head; and
means for removing the disposable powder supply bin from the system.

25. The system of claim 24, further comprising:
means for containing the powder in the powder bin; and
means for pushing the powder upward in the supply bin.

26. The system of claim 24, further comprising:
means for controlling the system;
means for communicating information about the powder to the means for controlling the system; and
means for receiving information from the sensor mechanism on the powder supply bin.
